(19) United States
(12) Patent Application Publication
(10) Pub. No.: US 2008/0245781 A1
(43) Pub. Date: Oct. 9, 2008

(54) METHOD FOR TANDEM WELDING

(76) Inventor: Gerald Wilhelm, Aichach (DE)

Correspondence Address: The BOC Group, Inc., 575 MOUNTAIN AVENUE, MURRAY HILL, NJ, 07974-2082, US

(21) Appl. No.: 12/045,746

(22) Filed: Mar. 11, 2008

(30) Foreign Application Priority Data
Apr. 3, 2007 (DE) 102007016103.6
Aug. 28, 2007 (EP) 07016841.4

(51) Int. Cl. B23K 9/09

(52) U.S. Cl. 219/130.51

(57) ABSTRACT

The invention relates to a method for the tandem welding of a workpiece with at least two fusible electrodes A and B to which different potentials are applied, wherein between electrode A and workpiece an impulse arc A and between electrode B and workpiece an impulse arc B burns and wherein the impulse arc A has at least one basic and one impulse current phase A with the frequency A and the impulse arc B has at least one basic and one impulse current phase B with the frequency B. According to the invention the frequency B is an integral multiple of the frequency A, while the impulse current phase A and the impulse current phase B do not overlap.

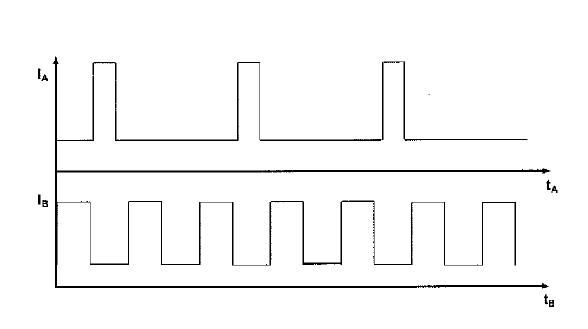

### CROSS REFERENCE TO RELATED APPLICATIONS

This application claims priority from European Patent Application No. 070168414, filed Aug. 28, 2007, which claims priority from German Patent Application No. 102007016103.6, filed Apr. 3, 2007.

### BACKGROUND OF THE INVENTION

The invention relates to a method for the tandem welding of a workpiece with at least two fusible electrodes A and B, to which different potentials are applied, wherein between electrode A and workpiece an impulse arc A and between electrode B and workpiece an impulse arc B burns and wherein the impulse arc A has a basic and an impulse current phase A with the frequency A and the impulse arc B has at least one basic and one impulse current phase B with the frequency B.

Different welding methods are employed for arc welding under protective gas. In addition to the method with fusible electrode, which includes metal active gas and metal inert gas welding, there are tungsten inert gas welding utilising a fusible electrode and plasma welding. To increase the productivity, high-performance welding methods have been increasingly employed in recent years. High-performance welding methods, which as a rule work with fusible electrodes, are characterized through higher fusion rates of the electrode compared with conventional metal protective gas welding. As electrodes, either wires with very large wire diameters are used for this purpose or the wire feed speed is higher than during conventional metal protective gas welding. The higher fusion rates can be converted into higher welding speeds or into higher weld seam volumes—compared with conventional welding. The basics of the metal protective gas high-performance welding are described in more detail in the information sheet of the German Association for Welding and Associated Methods e.V., DSV 0909-1 (September 2000) and DSV 0909-2 (June 2003).

In addition to the welding methods with a fusible electrode also customary with conventional welding there are also high-performance welding methods where two or several electrodes are fused, the so-called multiple wire processes. As a rule, two fusible electrodes are used but three or more electrodes are also possible. The electrodes melt in separate arcs under a common protective gas cover and, together with the melted workpiece material, form a common pool. Here, the electrodes are arranged behind one another or next to one another or obliquely to one another seen in welding direction. An arrangement behind one another is normally chosen for fusion welding, an arrangement obliquely to the welding direction (i.e. twisting relative to the welding direction) is of advantage for the gap bridging ability and with lap joints and an arrangement next to one another is usual with deposition welding. If two electrodes are used and these two electrodes are connected to a common potential it is called double wire welding. If, in contrast, the two electrodes are connected to different potentials this is called tandem welding. To realise tandem welding, two contact tubes, two power sources and two controls are therefore required, wherein the current sources however can also be coupled and operated in master-slave mode. Tandem welding is employed for both the creation of welded connections as well as deposition welding.

Welding protective gases containing helium are recommended for tandem welding in EP 1256410. EP 1707296 contains a method for tandem welding, with which the electrode leading in welding direction has a greater diameter than the trailing electrode. Methods with two different electrodes having a very large distance to each other and which, because of this do not form a welding pool but result in deposition in layers, are disclosed in JP 6234075, in JP 63154266 and in JP2092464.

Metal protective gas tandem welding offers the advantage that two wire electrodes are connected to separate potentials and the welding parameters of the two wire electrodes can therefore be set differently. It is possible for instance to apply a low voltage to the first arc so that a particularly deep weld penetration is created and a slightly higher voltage can be applied to the trailing arc, so that the weld seam becomes wider and preferably connects notch-free to the base material.

However, it is additionally possible to weld with identical wire diameters with significantly different wire feed speeds or to weld with different wire diameters and varying wire feed speeds. With the current control concepts for realising the alternating mode the first process is the master and the second one the slave; i.e. the pulse frequency of the first process is taken over for the second process and the process phase-shifted by a defined dimension so that the two impulse phases do not overlap each other. This control concept has limits when welding with identical or different wire diameters with highly varying wire feed speeds is to be performed. Since over a wide range the drop frequency of the wire feed speed is proportional and per period, consisting of an impulse current and a basic current phase, a drop is to fuse into the pool, the master-slave concept currently used as a base requires that with major differences in the wire feed speed the second process is supplied with an impulse frequency which does not at all correspond to its “natural” drop frequency (“natural” drop frequency means a drop per period). Particularly in the high-performance range this results in spatter and process instabilities.

### SUMMARY OF THE INVENTION

The invention is therefore based on the object of stating an improved method for tandem welding in the alternating mode with at least two fusible electrodes A and B.

According to the invention the object is solved in that the frequency B is an integral multiple of the frequency A, wherein the impulse current phase A and the impulse current phase B do not overlap.

### BRIEF DESCRIPTION OF THE DRAWING

The FIGURE shows an exemplary embodiment for impulse and basic current phases with which the electrodes A and B are operated.

### DETAILED DESCRIPTION OF THE INVENTION

The invention is explained in more detail in the following by means of the FIGURE. To this end, the FIGURE shows an exemplary embodiment for impulse and basic current phases with which the electrodes A and B are operated. Current against time are plotted for this purpose. The current curves are repeated with the frequency A and B respectively. Here, frequency B is an integral multiple of the frequency A. In addition, the current curves were selected so that the impulse current phases do not overlap. Thus it can be seen that during the basic current phase A two impulse current phases B occur and that during the impulse current A the basic current phase B takes place. The current curves are ideally shown and do not have any flanks. With the exemplary current curves shown it is possible to illustrate and explain in a particularly simple manner the method according to the invention. In practice, the current curves are predetermined by the welding task and consequently differ from this idealistic representation.

The invention thus makes possible selecting the differences in the wire feed speeds of the two processes in such a manner that the drop detachment of the second process, i.e. of the process B, is an integral multiple of the drop frequency of the first process designated A. With the help of a suitably modified control concept the impulse frequency is consequently set synchronously to the respective drop detachment frequency so that in each process a drop per period detaches in an optimal manner. With the invention it is thus ensured that an optimal “one drop per period detachment” is also realised in the second process designated B through optimal timing of the welding current as well as an impulse frequency, which is independent of the impulse frequency of the first process, matched to the process and as a result process instabilities and spatter formation, more preferably with metal protective gas high-performance welding are avoided. A “one drop per period detachment” in this case means that a drop fuses with the pool per period, wherein a period contains at least one impulse current and one basic current phase. The one drop per period mode made possible through the invention is characterized by particularly high process stability and particularly low spatter formation.

Thus, according to the invention, an impulse arc A with the frequency A burns between electrode A and workpiece and an impulse arc B with the frequency B between electrode B and workpiece, wherein the frequency B is an integral multiple of the frequency A. The impulse arcs A and B respectively are characterized through periodic repetition of the arc current with the frequency A and B respectively, while each arc current comprises at least one basic and one impulse current phase. Here, association of electrode A or B with a certain electrode in the tandem process does not exist as a matter of course. This means that both electrode A as well as electrode B can lead or trail or be arranged to the right or left of the welding direction.

With the method according to the invention it is possible to take into account the requirements of the individual electrodes while considering the overall effect of the electrodes on the welding process at the same time. The reason for this is that the impulse frequency for the electrodes can be selected largely independently of one another—however, only to the extent that there are no detrimental effects which are due to the interaction of the two electrodes. The requirements of the electrode are predetermined through the welding task, more preferably through the desired fusion rate. However the arcs of the electrodes jointly influence the welding process as well since only a pool is formed in which the arcs are active. The method according to the invention thus makes possible a stable and low-spatter tandem welding process even with high fusion rates.

Here it must be avoided that the impulse current phase A and the impulse current phase B overlap. To this end it is necessary that the impulse current phase A is sufficiently short and the basic current phase A is sufficiently long so that during the basic current phase A any number of impulse current phases B can occur. The period of the process B must therefore be selected so that the necessary number of periods and thus impulses can occur during the basic current phase A. Avoiding of overlaps of the impulse current phases means that only one arc at a time burns with maximum performance. Thus, with suitably low impulse current, the mutual influencing of the arcs is clearly lower than in the case of overlaps. Consequently by avoiding overlapping of the impulse phases (particularly preferably additionally in combination with low current values in the basic current phase) spatter formation is further reduced and process stability increased yet again.

In a particularly advantageous embodiment of the invention the electrode A has a different diameter than the electrode B. For with the method according to the invention it is possible, even with different electrode diameters, which require different welding parameters, to obtain a stable and low-spatter process since with the method according to the invention the requirements of the individual electrodes can be taken into account and the overall effect of the electrodes on the welding process can be considered. Thus, with the method according to the invention, for example during fusion welding, an electrode with larger diameter can be selected for the leading electrode and a smaller diameter for the trailing electrode, as a result of which both weld penetration and filling of weld volumes as well as formation of the seam surface are optimally supported. It is however also possible to use two identical wire diameters. With identical wire diameters the wire feed speeds will then differ from each other, so that despite identical wire diameters the desired “one drop per period detachment” will only be obtained with the method according to the invention.

Advantageously the electrode A has a different wire feed speed than the electrode B. Different setting of the wire feed speed also requires different welding parameters so that optimal process parameters are likewise only achieved here with the help of the method according to the invention.

Wire electrodes with a diameter between 0.8 and 2.5 mm are used with special advantages.

In an advantageous further development of the invention one or several current shoulders are inserted in the current drop from high-current phase to basic current phase. With current shoulders it is possible in certain cases to further increase the process stability and optimally support the drop detachment.

It can also be advantageous during the basic current phase to insert short intermediate impulses. This can also increase the process stability and support the drop detachment.

Gases or gas mixtures containing at least argon, helium, carbon dioxide, oxygen and/or nitrogen are used with advantage as protective gas. Establishing the suitable gas or the suitable gas mixture is performed as a function of the welding task, more preferably taking into account base and filler materials. The pure gases as well as two, three and multi-component mixtures are employed. In many cases, doped gas mixtures also prove particularly advantageous, while doped gas mixtures comprise dopes with active gases in the vpm range, i.e. doping is performed in the range of less than a percent, usually less than 0.1% by volume. Active gases, such as oxygen, carbon dioxide, nitrogen monoxide, laughing gas (dinitrogen monoxide) or nitrogen are used as doping gas.

Here it can be of advantage if a gas drag is employed. The use of a gas drag means that in addition to the protective gas surrounding the arcs directed at the pool a further protective gas flow is used. This further protective gas flow is directed against the workpiece with a comparatively weak flow rate and covers the fresh weld seam. The fresh weld seam is characterized in that the pool has already solidified but not yet cooled down. By using a gas drag it is thus ensured that even while cooling down the weld seam is still under protective gas. Since with the method according to the invention very much material is fused off the electrodes and deposited in the weld seam for filling the large welding volumes and the cooling-down of the weld seam therefore takes a relatively long time, the use of a gas drag is of advantage in many cases.

The method according to the invention is more preferably suitable when workpieces of steels or/and of aluminium/aluminium alloys are processed. Thus, it is more preferably suitable for all steel types including mild steels, fine-grain mild steels and stainless steels. In addition it is also suitable for nickel base materials. Use for other non-ferrous metals is likewise possible.

The method according to the invention is suitable for both fusion welding and deposition welding

1. A method for the tandem welding of a workpiece with at least two fusing electrodes A and B, to which different potentials are applied, wherein between electrode A and workpiece an impulse arc A and between electrode B and workpiece an impulse arc B burns and wherein the impulse arc A comprises at least one basic and one impulse current phase A with the frequency A and the impulse arc B comprises at least one basic and one impulse current phase B with the frequency B, characterized in that the frequency B is an integral multiple of the frequency A, wherein the impulse current phase A and the impulse current phase B do not overlap.

2. The method according to claim 1, characterized in that the electrode A has a different diameter than the electrode B.

3. The method according to claim 1, characterized in that the electrode A has a different wire feed speed than the electrode B.

4. The method according to claim 1, characterized in that wire electrodes with a diameter between 0.8 and 2.5 mm are used.

5. The method according to claim 1, characterized in that one or several current shoulders are inserted in the current drop from high-current phase to basic current phase.

6. The method according to claim 1, characterized in that short intermediate impulses are inserted during the basic current phase.

7. The method according to claim 1, characterized in that gases from the group consisting of argon, helium, carbon dioxide, oxygen, nitrogen and mixtures thereof are employed as protective gas.

8. The method according to claim 1, characterized in that workpieces of steels or/and of aluminium/aluminium alloys are processed.
